(19) United States
(12) Patent Application Publication
(10) Pub. No.: US 2010/0205322 A1
(43) Pub. Date: Aug. 12, 2010

(54) CONVERSION APPARATUS, DISTRIBUTION SYSTEM, DISTRIBUTION METHOD AND PROGRAM

(75) Inventor: Kazunori Ozawa, Tokyo (JP)

Correspondence Address: Mr. Jackson Chen, 6535 N. STATE HWY 161, IRVING, TX, 75039, US

(73) Assignee: NEC CORPORATION, Tokyo (JP)

(21) Appl. No.: 12/669,510

(22) PCT Filed: Jul. 28, 2008
(86) PCT No.: PCT/JP2008/063503

§ 371 Date: Jan. 18, 2010

(30) Foreign Application Priority Data
Jul. 30, 2007 (JP) 2007-197576

(51) Int. Cl. G06F 15/16

(52) U.S. Cl. 709/246

(57) ABSTRACT

A conversion apparatus receives contents information distributed from a source of distribution and transmits the contents information received to a destination of distribution. The apparatus comprises: a converting unit that converts a leading frame of the contents information to a non-predicted frame in response to a request from said destination of distribution.

### REFERENCE TO RELATED APPLICATION

This application is the National Phase of PCT/JP2008/063503, filed Jul. 28, 2008, which is based upon and claims the benefit of the priority of Japanese patent application No. 2007-197576 filed on Jul. 30, 2007, the disclosure of which is incorporated herein in its entirety by reference thereto.

### TECHNICAL FIELD

This invention relates to an apparatus for conversion, a distribution system, a distribution method, and a program, used in receiving the contents information distributed from a source of distribution, and in sending the so received contents information to a destination of distribution.

### BACKGROUND ART

Recently, distribution of the multimedia contents, inclusive of moving pictures, still pictures, audio or voice, is spreading in broadband or mobile environments. To distribute the multimedia contents to a terminal over an IP network, the following distribution system is now under investigation. That is, the multimedia contents are encoded and compressed to a stream and multicast or broadcast from a distribution server via the IP network to a station near a destination terminal in order to relieve the load otherwise imposed on the network. The station switches to uni-cast distribution, and distributes the multimedia contents over the IP network to the destination terminal, such as a set-top box, television receiver or personal computer in a home.

An example of this sort of the distribution system has been disclosed in, for example. Patent Document 1. This exemplary distribution system includes a contents server, a multimedia conversion server and a multimedia terminal. The multimedia conversion server accesses the contents server to acquire the HTML (Hyper Text Markup Language) and multimedia contents. The multimedia conversion server then converts the form of the multimedia contents and HTML to a form suitable for communication with the multimedia terminals and re-transmits the same to the multimedia terminal. The multimedia terminal then displays the multimedia contents in accordance with the so acquired HTML.

### [Patent Document 1]

JP Patent Kokai Publication No. JP-P2001-168923A

### [Patent Document 2]

JP Patent Kokai Publication No. JP-P2006-203682A

### SUMMARY

The entire disclosures of the above-mentioned Patent Documents 1 and 2 are incorporated herein by reference thereto. An analysis on the related technologies by the present inventor will be given below.

The above distribution system suffers a problem that, in a case where the terminal side switches the channel of the moving picture contents assume switching from CH1 (channel 1) to CH2 (channel 2), for example, then the picture of the CH2 cannot be displayed until arrival of a non-predicted frame in a stream upon switching to CH2.

There is also a problem that, if attempts are made to decode and display a predicted frame portion before arrival of the non-predicted frame, the picture is severely internal. In encoding moving pictures by an encoder, a time interval for a sequence of non-predicted pictures is set in order to generate a stream of moving picture contents. If this time interval is T seconds, the non-predicted picture arrives at the terminal only after T seconds in the worst case, with the result that a queuing time of T seconds persists in the worst case at a time of the channel switching. Hence, there is a possibility that an end user, accustomed to instant channel zapping of an analog TV, feels stressed with this queuing time and proceeds to call interruption without waiting.

It is a principal object of the present invention to provide an apparatus for conversion, a distribution system, a distribution method and a program, in which, in doing channel switching or channel zapping on the terminal side, the channel switching or channel zapping may be done instantly without queuing time without stressing the end user.

To solve the above problem, the present invention may be formulated substantially as follows:

In a first aspect, the present invention provides an apparatus for conversion that receives contents information distributed from a source of distribution and transmits the contents information received to a destination of distribution, in which the apparatus for conversion converts a leading frame of the contents information to a non-predicted frame in response to a request from the destination of distribution.

In a second aspect, the present invention provides a distribution system equipped with: the apparatus for conversion, defined as above, a distribution server as a source of distribution of the contents information to the apparatus for conversion, and a terminal that receives the contents information from the apparatus for conversion.

In a third aspect, the present invention provides a distribution method in which contents information distributed from a source of distribution is received and the contents information received is transmitted to a destination of distribution, in which the distribution method comprises: a step of converting a leading frame of the contents information to a non-predicted frame, in response to a request from the destination of distribution, and transmitting the resulting contents information to the destination of distribution.

In a fourth aspect, the present invention provides a program for allowing a computer to execute the processing of converting a leading frame of contents information, distributed from a source of distribution, to a non-predicted frame, in response to a request from a destination of distribution, and transmitting the resulting contents information to the destination of distribution. The computer forms an apparatus for conversion that receives the contents information and transmits the received contents information to the destination of distribution.

According to the present invention, when switching the channels, such as when switching the channel from CH1 to CH2, in the same session, the apparatus for conversion converts a leading frame in a stream of the channel as obtained after the switching, such as CH2, to an I frame or I-coded frame (referred to as a ‘non-predicted frame’). It is thus possible to realize instant channel switching. Hence, there occurs no phenomenon that, a decoded picture is disturbed for T seconds on the terminal side, as is met in the conventional art.

Moreover, the present invention has such a meritorious effect that, since the frames subsequent to the leading frame are output without conversion (in an unconverted state) as they are, it is possible to suppress deterioration ascribable to conversion to a small extent.

### BRIEF DESCRIPTION OF THE DRAWINGS

FIG. 1 is a block diagram showing an exemplary constitution of a distribution system according to a first exemplary embodiment of the present invention.

FIG. 2 is a block diagram showing an exemplary constitution of a distribution system according to a second exemplary embodiment of the present invention.

FIG. 3 is a block diagram showing an exemplary constitution of a syntax conversion transcoder of a conversion apparatus of the distribution system according to the second exemplary embodiment of the present invention.

FIG. 4 is a block diagram showing an exemplary constitution of a distribution system according to a third exemplary embodiment of the present invention.

FIG. 5 is a block diagram showing an exemplary constitution of a transcoder of a conversion apparatus of the distribution system according to the third exemplary embodiment of the present invention.

Explanations of symbols are given in the text.

Preferred Modes

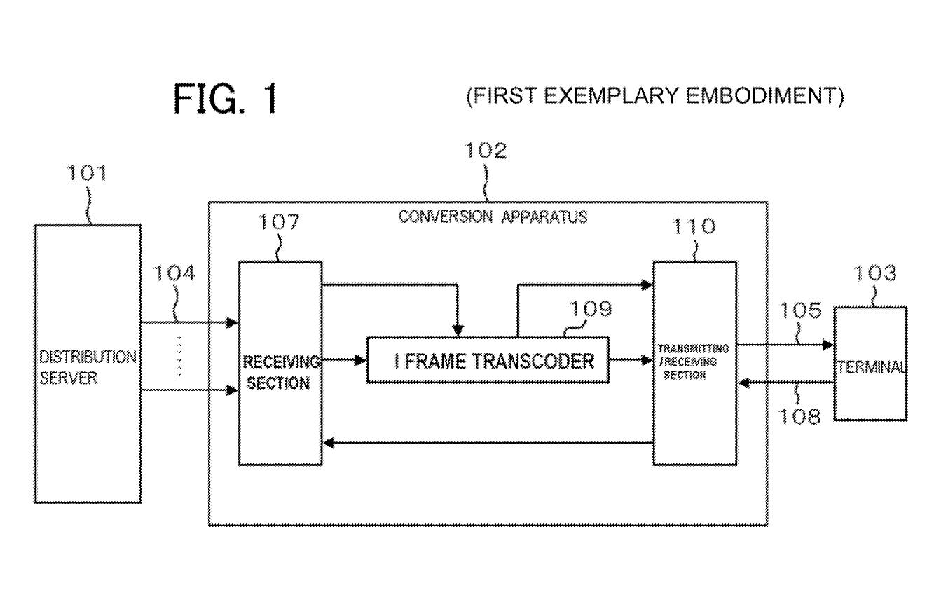

An conversion apparatus (102 of FIG. 1) according to an exemplary embodiment of the present invention receives contents information, for example, a stream, distributed from a source of distribution, which may, for example, be a distribution server 101 of FIG. 1, via a transmission medium, such as 104 of FIG. 1, and transmits the contents information received to a destination of distribution, such as a terminal 103 of FIG. 1, via a transmission medium, such as 105 of FIG. 1. The conversion apparatus converts a leading frame of the contents information to a non-predicted frame in response to a request from the destination of distribution, such as the terminal 103 of FIG. 1. This request may be a request for connecting the contents information or a request for switching the contents information.

A distribution system according to an exemplary embodiment of the present invention comprises a conversion apparatus (102 of FIG. 1), a distribution server (101 of FIG. 1), as a source of distribution of the contents information to the conversion apparatus, and a terminal (103 of FIG. 1). The terminal receives the contents information, such as moving pictures, a still picture, voice or audio, from the conversion apparatus.

The distribution method according to an exemplary embodiment of the present invention comprises the following steps:
Step 1: Contents information, for example, a stream containing at least one of moving pictures, a still picture, voice and audio, distributed from a source of distribution, which may be composed by the distribution server 101 of FIG. 1, over a transmission medium, such as 104 of FIG. 1, is received.
Step 2: The leading frame of the contents information received is converted to a non-predicted frame, in response to a request, such as a request for connection or switching of the contents information, from a destination of distribution (103 of FIG. 1).
Step 3: The contents information, whose leading frame has been converted to the non-predicted frame, is transmitted via a transmission medium, such as 105 of FIG. 1, to the destination of distribution, such as terminal 103 of FIG. 1.

A computer program according to an exemplary embodiment of the present invention allows a computer to execute the processing of converting a leading frame of contents information, such as a stream, distributed from a source of distribution, to a non-predicted frame, in response to a request from a destination of distribution, such as terminal 103 of FIG. 1, and transmitting the resulting contents information to the destination of distribution. The source of distribution may be the distribution server 101 of FIG. 1. The computer forms a conversion apparatus (102 of FIG. 1). The computer receives contents information and transmits the received contents information to the destination of distribution.

### FIRST EXEMPLARY EMBODIMENT

A distribution system according to a first exemplary embodiment of the present invention is now described with reference to the drawings. FIG. 1 depicts a block diagram showing a system configuration of a distribution system according to the first exemplary embodiment of the present invention.

Referring to FIG. 1, the distribution system of the present exemplary embodiment distributes contents from a distribution server 101 via an IP network, not shown, to a terminal 103. The present distribution system includes a distribution server 101, a conversion apparatus 102 and a terminal 103.

The distribution server 101 is a server that has a computer function, and stores the contents information for distribution and distributes the contents information.

The conversion apparatus 102 receives a stream, supplied thereto over a transmission route 104, such as a network, and distributes the stream to the terminal 103. When a request for connection or switching is made from the terminal 103, the conversion apparatus 102 converts a leading frame of the stream to a non-predicted frame, while outputting other frames as they are, that is, in an unconverted state.

The terminal 103 is able to communicate with the conversion apparatus 102 and also has a computer function. The terminal 103 has a function of decoding the stream from the conversion apparatus 102 and outputting the so decoded stream (a video output or an audio output).

The following is the manner of operation of the distribution system. It is presupposed that a plural number, for example, n, of compressed encoded bit streams of contents, inclusive of videos, have been pre-stored in the distribution server 101.

Initially, the distribution server 101 distributes the plural number, herein n, of the compressed encoded bit streams via a transmission route 104 to the conversion apparatus 102, using a multi-cast protocol or a broadcast protocol.

A receiving section 107 of the conversion apparatus 102 receives the n compressed encoded bit streams from the distribution server 101. The receiving section 107 then converts a multicast protocol or a broadcast protocol for each of the n compressed encoded bit streams to a uni-cast protocol.

In case a stream connection request is made by the terminal 103, the terminal 103 decides on at least one contents, for example, CH1, for distribution, out of the n (n CH) contents, subject to a user's operation, in order to request the distribution server 101 to make channel connection. The terminal 103 then transmits the so determined channel information over a transmission route 108 to the conversion apparatus 102.

A transmitting/receiving section 110 of the conversion apparatus 102 receives the channel information from the terminal 103 and sends the so received channel information from the transmitting/receiving section 110 to the receiving section 107.

The receiving section 107 then transmits, based on the channel information received, one of the n compressed encoded bit streams, which is relevant to the channel corresponding to the channel information, and the information necessary for decoding the compressed encoded bit stream (Decoder Configuration Information, DCI in acronym), to an I frame transcoder 109.

Then, when supplied with the compressed encoded bit stream and the DCI from the receiving section 107, the I frame transcoder 109 converts a leading frame in the compressed encoded bit stream to an I frame (non-predicted frame), and transmits the compressed encoded bit stream, the leading frame of which has been converted to the I frame, and the DCI, to the transmitting/receiving section 110. It should be noted that frames other than the leading frame of the compressed encoded bit stream remain unconverted.

When supplied with the compressed encoded bit stream and the DCI (those corresponding to the channel as selected by the terminal 103) from the I frame transcoder 109, the transmitting/receiving section (transponder) 110 sends the compressed encoded bit stream and the DCI, over a transmission route 105, such as a network, to the terminal 103, in accordance with, for example, a uni-cast protocol.

On the other hand, if a stream switching request is made from the terminal 103, the terminal 103 transmits the channel switching information, for example, the information for switching from CH1 to CH2, via the transmission route 108 to the conversion apparatus 102, subject to the user's actuation, in order to request the distribution server 101 to make channel switching.

The transmitting/receiving section 110 of the conversion apparatus 102 then receives the channel switching information from the terminal 103 and provides the so received channel switching information from the transmitting/receiving section 110 to the receiving section 107.

The receiving section 107 then transmits, based on the channel information received, one of the n compressed encoded bit streams, which is relevant to the channel corresponding to the channel switching information, such as CH2, and the information necessary for decoding the compressed encoded bit stream (Decoder Configuration Information, DCI in acronym), to the I frame transcoder 109.

Then, when supplied with the compressed encoded bit stream and the DCI from the receiving section 107, the I frame transcoder 109 converts a leading frame in the compressed encoded bit stream to an I frame (non-predicted frame), and transmits the resultant (I-framed converted) compressed encoded bit stream, the leading frame of which has been converted to the I frame, and the DCI, to the transmitting/receiving section 110. It should be noted that frames other than the leading frame of the compressed encoded bit stream remain unconverted.

When supplied with the compressed encoded bit stream and the DCI from the I frame transcoder 109, the transmitting/receiving section 110 transmits the so converted compressed encoded bit stream and the DCI in accordance with, for example, the uni-cast protocol, via the transmission route 105 to the terminal 103. It should be noted that the compressed encoded bit stream and the DCI, supplied to the transmitting/receiving section, are those relevant to the channel as selected by the terminal 103.

According to the present exemplary embodiment, in case the channel is switched in the same session, for example, from CH1 to CH2, the I frame transcoder 109 of the conversion apparatus 102 converts the leading frame of die stream of the channel following the switching, herein CH2, to an I frame, in such a manner as to realize instantaneous channel switching. In addition, it is possible to prevent the decoded image on the terminal side from being disturbed during T seconds as is the case with the aforementioned related art system. Further, the I frame transcoder 109 outputs frames following the leading frame as they are, that is, without, conversion, with the result that deterioration ascribable to conversion may be suppressed to only a small extent.

### SECOND EXEMPLARY EMBODIMENT

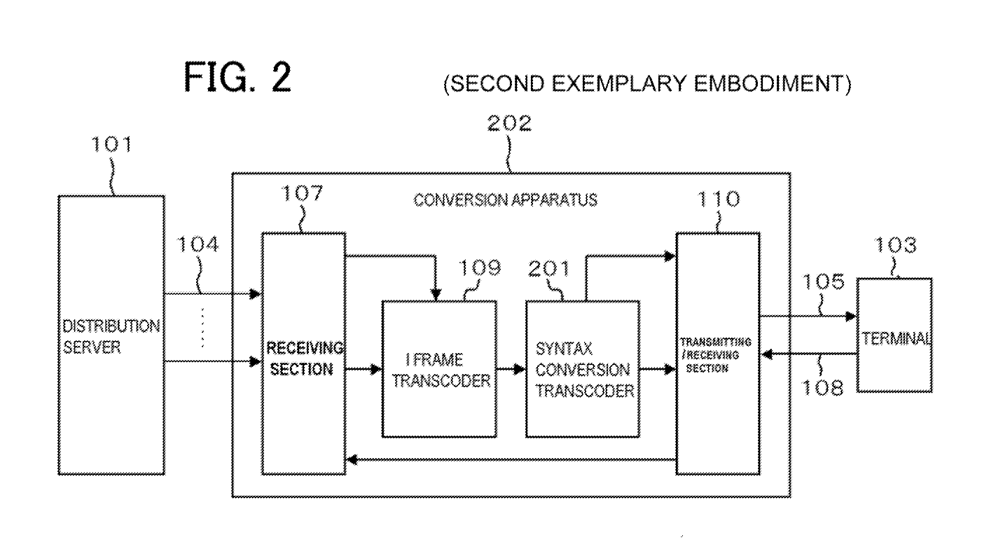

A distribution system according to a second exemplary embodiment of the present invention is now described with reference to the drawings. FIG. 2 depicts a block diagram showing a system configuration of a distribution system according to the second exemplary embodiment of the present invention.

Referring to FIG. 2, a conversion apparatus 202 of the distribution system according to the second exemplary embodiment of the present invention includes a syntax conversion transcoder 201 between the I frame transcoder 109 and the transmitting/receiving section 110. When supplied with the compressed encoded bit stream and the DCI from the I frame transcoder 109, the syntax conversion transcoder 201 converts the syntax of the compressed encoded bit stream, insofar as the leading frame and at least one of the following frames of the compressed encoded bit stream are concerned, depending on the contents of the DCI received. The syntax conversion transcoder 201 then outputs the so syntax-converted compressed encoded bit stream to the transmitting/receiving section 110. The present second exemplary embodiment is otherwise the same as the above-described first exemplary embodiment.

The operation of the distribution system of the present exemplary embodiment is now described. In the following, the description of the portion of the operation which is the same as the operation of the distribution system of the first exemplary embodiment is dispensed with.

On receipt of the channel switching information, such as that from CH1 to CH2, from the terminal 103, the transmitting/receiving section 110 of the conversion apparatus 202 sends the so received channel switching information to the receiving section 107.

The receiving section 107 then transmits, based on the so received channel switching information, one of the n compressed encoded bit streams, which is relevant to the channel switching information, such as CH2, and the information needed for decoding the compressed encoded bit stream (Decoder Configuration Information, DCI), to the I frame transcoder 109.

When supplied with the compressed encoded bit stream and the DCI from the receiving section 107, the I frame transcoder 109 converts the leading frame of the compressed encoded bit stream to an I frame (non-predicted frame) and sends the compressed encoded bit stream, the leading frame of which has been converted to the I frame, and the DCI, to the syntax conversion transcoder 201. It should be noted that frames other than the leading frame of the compressed encoded bit stream remain unconverted.

When supplied from the I frame transcoder 109 with the compressed encoded bit stream and the DCI, such as DCI for CH2, the syntax conversion transcoder 201 verifies whether or not the DCI of the CH2 is the same as that of the CH1.

If it is verified that the DCI of the CH2 is the same as that of the CH1, the syntax conversion transcoder 201 transmits the compressed encoded bit stream from the I frame transcoder 109 to the transmitting/receiving section 110 without doing frame syntax conversion of the compressed encoded bit stream supplied from the I frame transcoder 109.

If it is verified that the DCI of the CH2 is not the same as that of the CH1, the syntax conversion transcoder 201 converts the syntax of the leading frame and at least one of the succeeding frames of the compressed encoded bit stream supplied from the I frame transcoder 109, so that the DCI for CH2 will be the same as the DCI for CH1. The syntax conversion transcoder then transmits the so syntax-converted compressed encoded bit stream to the transmitting/receiving section 110.

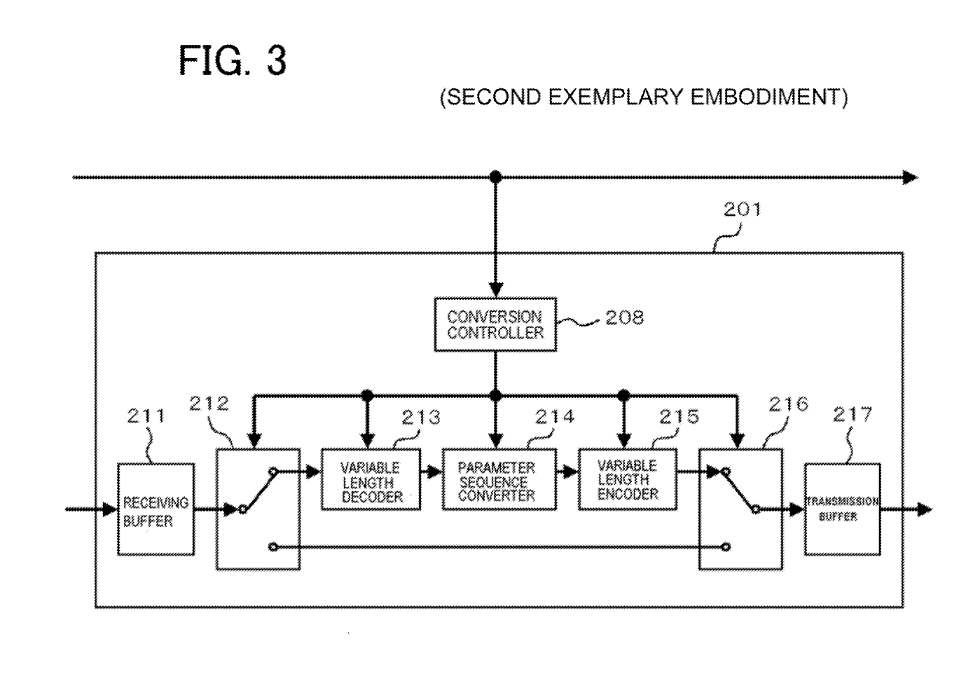

The formulation of the syntax conversion transcoder of FIG. 2 is now described. FIG. 3 depicts a detailed block diagram showing an exemplary formulation of the syntax conversion transcoder of FIG. 2.

Referring to FIG. 3, the syntax conversion transcoder 201 includes a conversion controller 208, a receiving buffer 211, a switching section 212, a variable length decoder 213, a parameter sequence converter 214, a variable length encoder 215, a switching section 216 and a transmission buffer 217. These will now be explained in detail.

The conversion controller 208 receives the DCI from the I frame transcoder (109 of FIG. 2), and compares the DCI (DCI after conversion) and the DCI before conversion, which is stored in the conversion controller 208, to each other, in order to verify whether or not the syntax is to be converted. The conversion controller transmits the ultimate conversion control Information to the switching section 212, variable length decoder 213, parameter sequence converter 214, variable length encoder 215 and to the switching section 216.

The compressed encoded bit stream from the I frame transcoder (109 of FIG. 2), e.g., a video packet of moving picture data, is stored once in the receiving buffer 211.

The switching section 212 switches between doing syntax conversion of the compressed encoded bit stream from the receiving buffer 211 (video packet) and not doing the syntax conversion of the compressed encoded bit stream, based on the conversion control information from the conversion controller 208.

In case of doing the syntax conversion, the state of the switching section 212 is turned such that the compressed encoded bit stream from the receiving buffer 211 (video packet) is supplied to the variable length decoder 213.

In case of not doing the syntax conversion, the state of the switching section 212 is turned such that the compressed encoded bit stream from the receiving buffer 211 (video packet) is supplied via the switching section 216 to the transmission buffer 217.

The variable length decoder 213 performs variable length decoding of parameters, other than A.C. components of the compressed encoded bit stream from the switching section 212 (video packet), using a regular VLC (variable length coding) code table. The variable length decoder 213 controls the variable length decoding in accordance with the conversion control information from the conversion controller 208.

If the variable length decoder 213 does not use an RVLC (Reversible Variable Length Code) for the A.C. components, it performs variable length decoding, using a regular VLC code table, not shown. If the variable length decoder uses the RVLC, it performs variable length decoding, using an RVLC code table, also not shown.

The variable length decoder 213 delivers a resultant compressed encoded bit stream (video packet), as obtained on variable length decoding, to the parameter sequence converter 214.

The parameter sequence converter 214 re-arrays a bit sequence of the compressed encoded bit stream (video packet), delivered after variable length decoding from the variable length decoder 213. The parameter sequence converter 214 controls the process of re-arraying the bit sequence in accordance with the conversion control information from the conversion controller 208. The parameter sequence converter 214 delivers the compressed encoded bit stream (video packet), whose bit sequence has been re-arrayed, to the variable length encoder 215.

The variable length encoder 215 variable length encodes only A.C. components, out of parameters of the compressed encoded bit stream (video packet), obtained on bit sequence re-arraying by the parameter sequence converter 214. The variable length encoder 215 controls the processing of variable length encoding, in accordance with the conversion control information from the conversion controller 208.

If the variable length encoder 215 does not use the RVLC, it performs the variable length encoding, using a regular VLC code table, not shown. If the variable length encoder uses the RVLC, it performs the variable length encoding, using an RVLC code table, also not shown.

The variable length encoder 215 delivers the compressed encoded bit stream (video packet), obtained on variable length encoding, to the switching section 216.

The switching section 216 switches between doing syntax conversion and not doing syntax conversion of the compressed encoded bit stream (video packet) obtained on variable length encoding from the variable length encoder 215, in accordance with the conversion control information from the conversion controller 208. In case of doing the syntax conversion, the switching section 216 delivers the compressed encoded bit stream (video packet) from the variable length encoder 215 to the transmission buffer 217 and, if otherwise (not doing the syntax conversion), delivers the compressed encoded bit stream (video packet) from the switching section 212 directly to the transmission buffer 217.

The transmission buffer 217 stores the compressed encoded bit stream (video packet) from the switching section 216 once and subsequently delivers the so stored compressed encoded bit stream to the transmitting/receiving section (110 of FIG. 2).

As for details of the formulation of the syntax conversion transcoder of FIG. 3, see also the description of Patent Publication 2, filed in the name of the present Assignee.

The present exemplary embodiment gives a meritorious result similar to that of the first exemplary embodiment. In addition, when it is desired to switch from a given channel to another channel in the same session, the syntax of the stream following the switching is converted. Hence, session re-connection is unnecessary, in contrast to the conventional technique described above, so that only a short time suffices to switch from a given channel, such as CH1, to another channel, such as CH2.

### THIRD EXEMPLARY EMBODIMENT

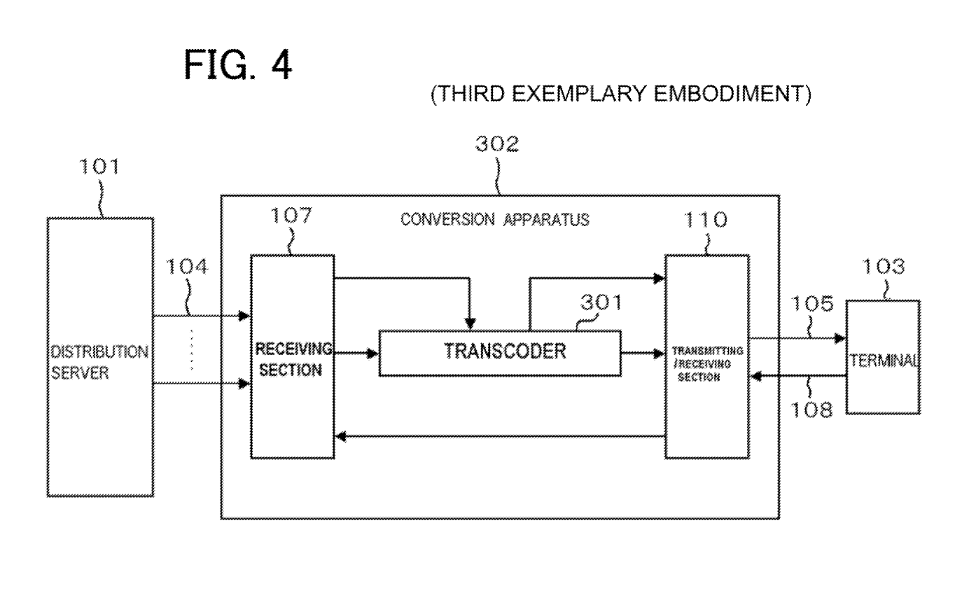

A distribution system according to a third exemplary embodiment of the present invention is now described with reference to the drawings. FIG. 4 depicts a block diagram showing a system configuration of a distribution system according to the third exemplary embodiment of the present invention.

Referring to FIG. 4. the distribution system according to the third exemplary embodiment of the present invention includes, in a conversion apparatus 302, a transcoder 301 in place of the I frame transcoder (109 of FIG. 1) of the first exemplary embodiment When supplied with the compressed encoded bit stream and with the DCI from the receiving section 107, the transcoder 301 converts the leading frame of the bit stream to an I frame (non-predicted frame), while converting at least one of succeeding frames following the leading frame into a P frame (predicted frame), to generate an as-converted compressed encoded bit stream. The transcoder 301 sends the resultant compressed encoded bit stream and the DCI, as obtained after the conversion, to the transmitting/receiving section 110. In other respects, the present third exemplary embodiment is similar to the first exemplary embodiment.

The following is the operation of the distribution system of the third exemplary embodiment. It should be noted that the portion of the operation which is the same as the operation of the distribution system of the first exemplary embodiment is dispensed with.

If, in case a request for stream connection is made from the terminal 103, the transmitting/receiving section 110 of the conversion apparatus 302 has received the channel information from the terminal 103, the conversion apparatus 302 sends the so received channel information from the transmitting/receiving section 110 to the receiving section 107.

The receiving section 107 transmits, based on the channel information from the transmitting/receiving section 110, one of the n compressed encoded bit streams which is relevant to a channel corresponding to the channel information, and decoding information needed to decode the compressed encoded bit stream (Decoder Configuration Information, DCI), to the transcoder 301.

When supplied with the compressed encoded bit stream and the DCI from the receiving section 107, the transcoder 301 converts the leading frame of the bit stream to an I frame (non-predicted frame), while converting succeeding frames following the leading frame into P frames (predicted frames), to generate an as-converted compressed encoded bit stream. The transcoder then delivers the resultant compressed encoded bit stream and the DCI, as obtained after the conversion, to the transmitting/receiving section 110.

When supplied from the transcoder 301 with the compressed encoded bit stream and the DCI, relevant to a channel, as selected by the terminal 103, the transmitting/receiving section 110 transmits the compressed encoded bit stream and the DCI via the transmission route 105 to the terminal 103, in accordance with a uni-cast protocol, for instance,

In case a request is made for stream switching from the CH1 to the CH2, for example, from the terminal 103, the transmitting/receiving section 110 of the conversion apparatus 302 receives a channel switching information (signal) from the terminal 103. The conversion apparatus 302 then delivers the so received channel switching information from the transmitting/receiving section 110 to the receiving section 107.

The receiving section 107 transmits, based on the channel switching information (signal) received, one of the n compressed encoded bit streams which is relevant to the channel corresponding to the channel information (CH2), and the information needed to decode the compressed encoded bit stream (Decoder Configuration Information, DCI) to the transcoder 301.

When supplied with the compressed encoded bit stream and the DCI, relevant to CH2, from the receiving section 107, the transcoder 301 once decodes the bit stream with the DCI for the CH2 to generate a picture signal. The transcoder then re-encodes the decoded picture signal with the DCI for the CH1 to generate a compressed (encoded) bit stream in which the leading frame has been re-encoded to an I frame (non-predicted frame) and the frames succeeding the leading frame of the compressed encoded bit stream have been re-encoded to P frames (predicted frames). The transcoder transmits the re-encoded bit stream and the DCI for the CH1 to the transmitting/receiving section 110.

When supplied with the re-encoded bit stream and with the DCI for the CH1 from the transcoder 301, the transmitting/receiving section 110 transmits the re-encoded bit stream and the DCI via the transmission route 105 to the terminal 103 in accordance with the uni-cast protocol, for instance.

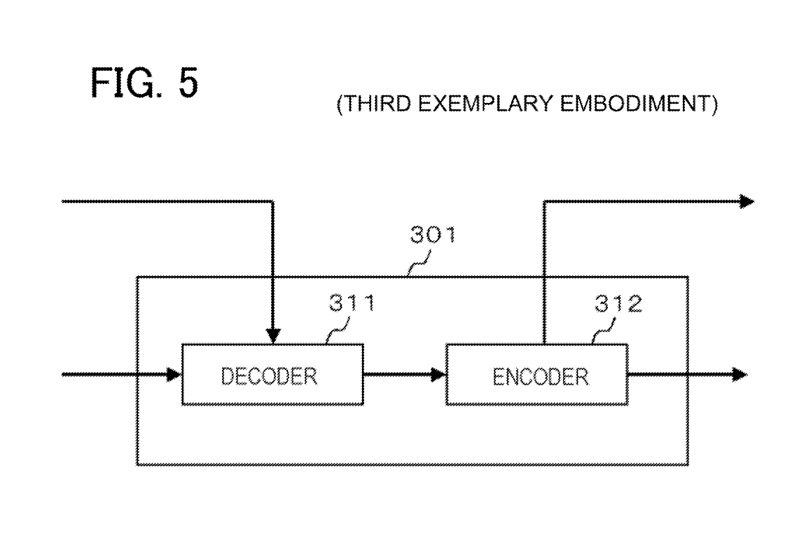

The formulation of the transcoder of the present exemplary embodiment is now described. FIG. 5 depicts a block diagram showing the formulation of a transcoder of the conversion apparatus of FIG. 4.

Referring to FIG. 5, the transcoder 301 includes a decoder 311 and an encoder 312.

When supplied with the DCI and the compressed encoded bit stream from the receiving section (107 of FIG. 4), the decoder 311 sets the DCI to decode the compressed encoded bit stream, and delivers the decoded signal to the encoder 312.

The encoder 312 sets the decoding method, based on the as-modified (or updated) DCI, and receives the decoded signal to re-encode it The encoder 312 then delivers the re-encoded bit stream and the as-modified DCI to the transmitting/receiving section (110 of FIG. 4).

The present exemplary embodiment yields the meritorious effect similar to that of the first exemplary embodiment.

The disclosures of the above-listed Patent Publications are to be incorporated herein by reference. The exemplary embodiments or examples can be changed or adjusted within the framework of the entire disclosure of the present invention, inclusive of the claims, based on the fundamental technical concept of the invention. Various combinations or selections of disclosed elements are also possible within the framework of the claims of the present invention. That is, the present invention naturally comprises various changes or corrections that may be made by those skilled in the art based on the entire disclosures, inclusive of claims, and on its technical concept.

In the present Invention there are various modes as set forth below.
Mode 1. A distribution system according to the second aspect.
Mode 2. The distribution system according to mode 1, wherein
   said conversion apparatus receives a stream containing at least one of a moving picture, a still picture, voice and audio from said distribution server over a network by multicast or broadcast and distributes the received stream over a network to said terminal; and wherein
   in case a stream connecting request or a stream switching request is made from said terminal, said conversion apparatus converts the leading frame of said stream to a non-predicted frame and outputs frames other than said leading frame in an unconverted state.
Mode 3. The distribution system according to mode 1, wherein
   said conversion apparatus receives a stream containing at least one of a moving picture, a still picture, voice and audio from said distribution server over a network by multicast or broadcast and distributes the received stream over a network to said terminal; and wherein
   in case a stream connecting request or a stream switching request is made from said terminal, said conversion apparatus converts the leading frame of said stream to a non-predicted frame and outputs frames other than said leading frame in an unconverted state; said conversion apparatus converting syntax of said stream insofar as the leading frame and at least one of frames succeeding to said leading frame are concerned, and outputting the resulting stream.
Mode 4. The distribution system according to mode 1, wherein
   said conversion apparatus receives a stream containing at least one of a moving picture, a still picture, voice and audio from said distribution server over a network by multicast or broadcast and distributes the received stream over a network to said terminal; and wherein
   in case a stream connecting request or a stream switching request is made from said terminal, said conversion apparatus converts the leading frame of said stream to a non-predicted frame and outputs frames other than said leading frame in an unconverted state; said conversion apparatus converting at least one of said succeeding frames to a predicted frame.
Mode 5. A distribution method according to the third aspect.
Mode 6. The distribution method according to mode 5, wherein frames of said contents information other than the leading frame are output in an unconverted state to said destination of distribution.
Mode 7. The distribution method according to mode 5, wherein
   the leading frame of the contents information is converted to a non-predicted frame, in response to a request for switching the contents Information from said destination of distribution;
   it is then verified whether or not the decoding information before switching the contents information is the same as the decoding information after switching the contents information, and wherein
   If said decoding information before switching the contents information is not the same as the decoding information after switching the contents information, syntax of the leading frame and at least one of frames in said contents information succeeding to said leading frame is converted so that said decoding information before switching the contents information will be the same as the decoding information after switching the contents information.
Mode 8. The distribution method according to mode 5, wherein
   the leading frame is converted to a non-predicted frame, and frames other than said leading frame are output in an unconverted state, in response to a request from said destination of distribution; and wherein
   at least one of said succeeding frames is converted to a predicted frame.
Mode 9. A program for allowing a computer to execute the processing according to the fourth aspect.
Mode 10. The program according to mode 9, wherein
   said program allows said computer to execute the processing of outputting frames of said contents Information other than said leading frame in an unconverted state to said destination of distribution.
Mode 11. The program according to mode 9 for allowing said computer to execute the following processing:
   converting the leading frame of the contents information to a non-predicted frame, in response to a request for switching the contents information from said destination of distribution;
   verifying whether or not the decoding information before switching the contents information is the same as the decoding information after switching the contents information; and
   converting, if said decoding information before switching is not the same as the decoding information after switching, syntax of the leading frame and at least one of said succeeding frames in said contents information, so that said decoding information before switching will be the same as the decoding information after switching.
Mode 12. The program according to mode 9 for allowing said computer to execute the following processing:
   converting the leading frame into a non-predicted frame, in response to a request from said destination of distribution;
   outputting frames other than said leading frame in an unconverted state, and
   converting at least one of said succeeding frames to a predicted frame.

What is claimed is:

1. A conversion apparatus that receives contents information distributed from a source of distribution and transmits the contents information received to a destination of distribution; said conversion apparatus comprising:
a converting unit that converts a leading frame of said contents information to a non-predicted frame in response to a request from said destination of distribution.

2. The conversion apparatus according to claim 1, wherein frames other than the leading frame of said contents information are transmitted in an unconverted state to said destination of distribution.

3. The conversion apparatus according to claim 1, wherein said request from said destination of distribution is a request for connection or switching of the contents information.

4. The conversion apparatus according to claim 1, further comprising:
a receiving section that receives the contents information distributed from said source of distribution;
a transcoder that decodes the contents information received from said receiving section, subsequently encodes the decoded contents information, and outputs the resulting contents information; and
a transmitting/receiving section that receives said request from said destination of distribution, and transmits the contents information output from said transcoder to said destination of distribution.

5. The conversion apparatus according to claim 4 wherein, in case of receipt of said request from said destination of distribution, said transmitting/receiving section notifies said receiving section of said request;
in case of receipt of said notification, said receiving section provides said transcoder with the information for decoding of the contents information DCI; and wherein
said transcoder converts the leading frame of said contents information from said receiving section to a non-predicted frame.

6. The conversion apparatus according to claim 1, further comprising:
a unit that converts, in response to a request for switching the contents information from said destination of distribution, the leading frame of said contents information to a non-predicted frame, and subsequently verifies whether or not the decoding information before switching of said contents information is the same as the decoding information after switching of said contents information; wherein
said unit converts, in case the decoding information before switching of said contents information is not the same as the decoding information after switching of said contents information, syntax of said leading frame and syntax of at least one of the frames succeeding to said leading frame in said contents information so that the decoding information before switching of said contents information will be the same as the decoding information after switching of said contents information.

7. The conversion apparatus according to claim 6, wherein, if the decoding information before switching is the same as the decoding information after switching, said leading frame and said succeeding frame or frames are output to said destination of distribution without converting the syntax of said leading frame and said succeeding frame or frames.

8. The conversion apparatus according to claim 6 further comprising:
a receiving section that receives the contents information distributed from said source of distribution;
a first transcoder that decodes the contents information received by said receiving section and subsequently encodes the decoded contents information to output the resulting contents information;
a second transcoder that decodes the contents information output from said first transcoder and subsequently encodes the decoded contents information to output the resulting contents information; and
a transmitting/receiving section that receives said request from said destination of distribution and transmits the contents information output from said second transcoder to said destination of distribution.

9. The conversion apparatus according to claim 8, wherein, in case of receipt of said request from said destination of distribution, said transmitting/receiving section notifies said receiving section of said request;
in case of receipt of said notification, said receiving section provides said first transcoder and said second transcoder with the information for decoding DCI; and wherein
said first transcoder converts the leading frame of said contents information from said receiving section to a non-predicted frame;
said second transcoder verifying, in case the request from said destination of distribution is a request for switching the contents information, whether or not the decoding information before switching of said contents information output from said first transcoder is the same as the decoding information after switching of said contents information; said second transcoder converting, in case said decoding information before switching of said contents information is not the same as the decoding information after switching of said contents information, the syntax of said leading frame and said at least one of said succeeding frames in said contents information so that said decoding information before switching of said contents information will be the same as the decoding information after switching of said contents information.

10. The conversion apparatus according to claim 8 wherein said second transcoder includes:
a conversion controller that compares the encoding information as set by said receiving section to the encoding information before setting to output the conversion control information that determines whether or not the syntax is to be converted;
a receiving buffer that stores the contents information from said first transcoder once;
a first switching section that switches between doing and not doing conversion of the syntax in the contents information from said receiving buffer in accordance with said conversion control information from said conversion controller;
a variable length decoder that performs variable length decoding of parameters other than A.C. components of the contents information supplied from said first switching section, using a first code table, in case of not using a Reversible Variable Length Code RVLC, in accordance with said conversion control information supplied from said conversion controller; said variable length decoder performing variable length decoding of said parameters other than said A.C. components, using a second code table, other than said first code table, in case of using the RVLC;
a parameter sequence conversion section that re-arrays a bit sequence of the contents information from said variable length decoder in accordance with said conversion control information supplied from said conversion controller;
a variable length encoder that performs variable length encoding of parameters of A.C. components of the contents information from said parameter sequence conversion section, using said first code table, in case of not using the RVLC, in accordance with said conversion control information supplied from said conversion controller; said variable length encoder performing variable length encoding of said parameters of said A.C. components, using said second code table, in case of using the RVLC;
a second switching section that switches between doing and not doing conversion of the syntax in the contents information from said variable length encoder in accordance with said conversion control information supplied from said conversion controller; and
a transmission buffer that stores said contents information from said second switching section once and subsequently outputs the stored contents information to said transmitting/receiving section.

11. The conversion apparatus according to claim 1, wherein, in response to a request from said destination of distribution, a leading frame is converted to a non-predicted frame, and frames other than said leading frame are output in an unconverted state; and wherein
at least one of the succeeding frames is converted to a predicted frame.

12. The conversion apparatus according to claim 11, further comprising:
a receiving section that receives the contents information distributed from said source of distribution;
a transcoder that decodes the contents information received by said receiving section, encodes the decoded contents information, and that outputs the resulting contents information; and
a transmitting/receiving section that receives a request from said destination of distribution and transmits the output contents information from said transcoder to said destination of distribution.

13. The conversion apparatus according to claim 12, wherein
in case of receipt of said request from said destination of distribution, said transmitting/receiving section notifies said receiving section of said request;
in case of receipt of said notification, said receiving section provides said transcoder with the information for decoding DCI; and wherein
said transcoder converts the leading frame of said contents information from said receiving section to a non-predicted frame; said transcoder converting frames succeeding to said leading frame to predicted frames.

14. The conversion apparatus according to claim 1, wherein the information distributed from said source of distribution includes a stream containing at least one of a moving picture, a still picture, voice and audio.

15. The conversion apparatus according to claim 1, wherein the information distributed from said source of distribution is received by a multicast protocol or a broadcast protocol.

16. The conversion apparatus according to claim 15 wherein, in case of receipt of the information distributed from said source of distribution, the multicast protocol or the broadcast protocol is changed to a uni-cast protocol.

17. A distribution system comprising:
the conversion apparatus according to claim 1;
a distribution server as a source of distribution of the contents information to said conversion apparatus; and
a terminal that receives the contents information from said conversion apparatus.

18-20. (canceled)

21. A distribution method in which contents information distributed from a source of distribution is received and the contents information received is transmitted to a destination of distribution;
wherein said distribution method further comprises:
converting, in response to a request from said destination of distribution, a leading frame of said contents information to a non-predicted frame, and
transmitting the resulting contents information to said destination of distribution.

22. The distribution method according to claim 21, wherein frames of said contents information other than the leading frame are output in an unconverted state to said destination of distribution.

23. The distribution method according to claim 21, wherein
the leading frame of the contents information is converted to a non-predicted frame, in response to a request for switching the contents information from said destination of distribution;
it is then verified whether or not the decoding information before switching the contents information is the same as the decoding information after switching the contents information, and wherein
if said decoding information before switching the contents information is not the same as the decoding information after switching the contents information, syntax of the leading frame and at least one of frames in said contents information succeeding to said leading frame is converted so that said decoding information before switching the contents information will be the same as the decoding information after switching the contents information.

24-28. (canceled)
